(19) United States
(12) Patent Application Publication
(10) Pub. No.: US 2014/0165740 A1
(43) Pub. Date: Jun. 19, 2014

(54) ULTRASOUND TRANSDUCER AND METHOD OF GENERATING AND/OR RECEIVING ULTRASOUND

(71) Applicant: SICK AG, Waldkirch (DE)

(72) Inventor: Michael SPEIDEL, Waldkirch (DE)

(73) Assignee: SICK AG, Waldkirch (DE)

(21) Appl. No.: 14/082,231

(22) Filed: Nov. 18, 2013

(30) Foreign Application Priority Data
Dec. 13, 2012 (EP) 12196843.2

(51) Int. Cl. B06B 1/06; G01F 1/66

(52) U.S. Cl. CPC B06B 1/0685; G01F 1/662
USPC 73/861.28; 310/327

(57) ABSTRACT

An ultrasound transducer (10) is provided having an oscillating body (12) for generating and/or receiving ultrasound and having a damping body (14) which has a first part body (16) of a first material arranged at a rear side of the oscillating body (16), said first material having an acoustic impedance matched to a material of the oscillating body (12), and which has a second part body (18) of a second material arranged at the first part body (16), said second material having a high acoustic damping. In this respect, the first part body (16) is conical and its base surface is arranged on the oscillating body (12).

The invention relates to an ultrasound transducer and to a method of generating and/or receiving ultrasound in accordance with the preamble of claims 1 and 20 respectively.

Ultrasound transducers have an oscillatory membrane, frequently a ceramic material. An electric signal is converted into ultrasound, and vice versa, with its aid on the basis of the piezoelectric effect. Depending on the application, the ultrasound transducer works as a sound source, as a sound detector or as both.

One use of ultrasound transducers is the flow measurement of fluids in conduits using the differential transit time method. In this respect, a pair of ultrasound transducers is mounted with mutual offset in the longitudinal direction at the outer periphery of the conduit, said pair of ultrasound transducers transmitting and registering ultrasonic signals alternatingly transversely to the flow along the measurement path spanned between the ultrasound transducers. The ultrasonic signals transported through the fluid are accelerated or decelerated by the flow depending on the running direction. The resulting transit time difference is used in calculations with geometrical parameters to form a mean flow speed of the fluid. The volume flow or throughflow results from this with the cross-sectional area. For more exact measurements, a plurality of measurement paths each having a pair of ultrasound transducers can also be provided to detect a flow cross-section at more than one point.

On such a throughflow measurement, the ultrasound has to be coupled into the fluid by the transducers. For this purpose, the ultrasound transducers are as a rule mounted in the interior space of the conduit so that the membrane is in direct contact with the fluid. The transducers immersed in this manner are, however, exposed to the fluid and to its pressure and temperature and will thereby possibly be damaged. Conversely, the transducers can disturb the flow and can therefore impair the accuracy of the measurement.

EP 1 378 727 B1 proposes attaching the ultrasound-generating elements to an outer side of a wall. The membrane in this respect becomes part of the wall which has a substantially lower wall thickness in the corresponding region than the remaining wall.

Instead of only having to overcome the transition between the transducer and the fluid, the ultrasound has to overcome an actual plurality of interfaces having acoustic impedance jumps from the ceramic material to the pipe wall and on to the fluid with transducers mounted in this manner. These impedance jumps produce wave reflections at the medium boundaries, which has a great influence on the signal shape of the pulse to be transmitted in the time range and reduces the irradiated power. Further disturbances arise due to reflections into the fluid of the ultrasound exiting at the rear side of the membrane.

It is known in the prior art to compensate the impedance jumps between the membrane and the medium by adaptation layers (matching layers). A good matching can be achieved relatively simply by a 274 thickness ratio for narrow band systems. The power irradiated at the rear side is thus also kept small. Since, however, by definition a 274 layer is dependent on the wavelength, suitable matching layers of different thickness can only be realized with great difficulty for broadband systems.

Conventional ultrasound transducers on the rear side use a mechanical damping block (backing) to suppress reflections in the actual irradiation direction. The back reflections then remain small just when there is only a small acoustic impedance jump between the membrane and the absorber material. Accordingly a material is wanted which simultaneously has an acoustic impedance close to the membrane and a high acoustic damping. Such material properties can, however, not be found in a single material.

A known solution approach comprises the use of composites of an acoustically hard material for impedance matching to the membrane and an acoustically soft epoxy resin for the damping. In this respect, the desired impedance and damping is combined via the volume mixing ratio. The production is disadvantageous in this respect since the structure has to be produced at high pressure in a time-intensive manner to avoid air inclusions through bubble formation. In addition, there are practical difficulties in reproducibly setting the mixing ratios for the theoretically required impedances and damping processes. Particularly in combinations having a high impedance and high damping, the required layer thickness also becomes large very quickly and reaches an order of magnitude of centimeters. Such a composite layer is thus no longer suitable for a small-size system having total dimensions in the millimeter range. A further disadvantage is represented by the thermal variation of the resin in the composite whose viscosity then brings about age-induced variations in the transfer behavior of the ultrasound transducer. Temperatures also influence the adhesion of the different matching layers to one another and on the membrane. This is particularly problematic in the case of high fluid temperatures and efficient thermal coupling, for example in a metal conduit.

An ultrasound transducer is known from US 2005/0075571 A1 for converting between acoustic and electrical energy using a backing which has a sound-absorbing surface. This surface is the interface between a metal block and a damping epoxy resin body. The interface forms a landscape of peaks and valleys in which the ultrasound is lost due to multiple reflections. This ultrasound transducer, which is proposed for medical technology, is, however, not suitable for small-size throughflow meters having high measurement precision.

It is therefore the object of the invention to provide a compact ultrasound transducer having improved irradiation behavior.

This object is satisfied by an ultrasound transducer and by a method for generating and/or receiving ultrasound in accordance with claims 1 and 20 respectively. In this respect, the invention starts from the basic idea of suppressing the rearward irradiation of ultrasound with the aid of a damping body (backing). This backing has a first material adapted to the acoustic impedance of the oscillating body and a second material having high acoustic damping. Both materials form separate part bodies, that is are not mixed to form a composite, although certain contaminations of the materials of the part bodies remain acceptable as a rule. The damping effect arises due to the geometry in that the first part body is conical and is arranged with its base surface on the oscillating body. An interface at the inner jacket surface of the cone is thereby provided for the ultrasound which is sufficiently slanted for a forward scattering as a basis of a multiple reflection in the cone. Provided that ultrasound again returns in the direction of the oscillating body after a plurality of reflections, a large part of the sound energy has been absorbed in the second part body.

The invention has the advantage that a good damping behavior is reached. Only a little ultrasound is irradiated to the front from the rear side in a superimposed manner and there is therefore in particular at most a brief post-pulse oscillation after an ultrasound pulse. The matching of the ultrasound transducer takes place, unlike with matching layers, for a large bandwidth without the damping body requiring too great a thickness. A broadband ultrasound transducer having a short construction size is thus provided. At the same time, the manufacture is simpler and less expensive since, unlike matching layers and composites, neither complicated manufacturing processes nor complex materials are required.

The damping body is preferably cylindrical in that the second part body has a cylindrical outer contour and a conical hollow space for receiving the first part body. Cylindrical is in particular to be understood here in the narrow sense of a straight circular cylinder. The second part body is in this respect a cylinder having a hollow cone which forms the counter-piece to the first part body to receive it therein. A cylindrical ultrasound transducer which is easy to handle thus arises overall.

The oscillating body, the first part body and the second part body are preferably held together by a compressive force along the cone axis, in particular by means of a spring force which acts on the second part body or by means of a housing cover screwed onto the second part body. The ultrasound transducer can be composed of a conical first part body and a complementary second part body without adhesion points due to the damping body and is centered automatically due to the geometry with a corresponding compressive force. This manufacture purely by compressive pressure is extremely simple and results in a high resistance, for example with respect to temperature variations, due to the adhesive-free connections.

The jacket surface of the cone preferably includes an angle between 60° and 70° with the base surface. An angle above 60° ensures that, when ultrasound is incident at the interface, forward scattering is incident further in the cone interior and thus a multiple reflection occurs. The mode coupling at the interfaces, however, also no longer assists the damping as well with angles which are too large and which are not below 70°. In addition, the construction height also increases with the included angle. A particularly good damping results at an angle of 65°. It is, however, sufficient to reach this optimum with certain tolerances since deviations of a few degrees do not yet have too great an effect.

The first part body preferably has a cylindrical base having a larger radius than the base surface of the cone. The first part body therefore forms a cone which is seated somewhat set back on the somewhat larger base and leaves a peripheral shoulder free there. This is useful because the complementary second part body does not have to have any peripheral sharp edge in this manner, but can rather have a certain thickness in accordance with the shoulder. Such a second part body can be manufactured more easily depending on the material used for it.

The second part body preferably surrounds the cone, but not the cylindrical base of the first part body. The first material thus forms the outer jacket of the damping body up to a height of the socket and the second material forms the outer jacket for the remaining height. The first material can thereby be contacted from the outside. In addition, the interface would anyway not be impacted by ultrasound in the base region so that the second body would not provide any damping contribution here.

The material of the oscillating body is preferably a ceramic material. Such materials are available and bring about the required piezoelectric properties. For example, PZT (lead zirconate titanate) having an acoustic impedance in the range of 35 MRayl is used.

The first material is preferably brass, in particular CuZn39Pb2. Brass has an acoustic impedance matching the ceramic material. In addition, brass provides technical production advantages since it can be brought into the required conical shape comparatively simply by turning.

The second material is preferably a plastic, in particular PTFE. Plastics strongly damp the ultrasound. In particular PTFE (polytetrafluoroethylene) is highly damping and thereby allows small construction heights and is simultaneously mechanically stable and temperature-resistant.

The oscillating body preferably has a first electrode on a front side disposed opposite the rear side and has a second electrode on the rear side, with a part region of the first electrode being drawn around the oscillating body up to the rear side and being contacted there and the second electrode being contacted via the first part body. The front side is not accessible on a mounting of the ultrasound transducer directly on another material. The first electrode is therefore made directly accessible and contactable from the rear side in this embodiment. The metallic first part body is anyway in communication with the second electrode as a rule so that the second electrode can be contacted somewhere at the first part body.

The first part body preferably has a cut-out. This cut-out corresponds at least in part to the drawn-around part of the first electrode in order here to allow a contact by a connector line and to avoid a short circuit of the two electrodes by a metallic first part body.

In an advantageous further development, an ultrasound throughflow measurement apparatus for measuring the flow speed of fluids in a conduit is provided which has a measurement body which can be inserted into the conduit and in this manner forms a section of the conduit, said measurement body having at least one pair of ultrasound transducers in accordance with the invention arranged therein, and also has an evaluation unit for determining the flow speed from a transit time difference of ultrasound transmitted and received with and against the flow. The fluid to be measured is, for example, a liquid having an acoustic impedance similar to water such as is used in the food industry, in pharmaceutics or similar applications with a high demand on accuracy and hygiene. In this respect, conduits of a resistant stainless steel which is easy to clean are frequently used so that the measurement body is also preferably manufactured from steel to fit into the conduit. On the other hand, steel has a high temperature transfer so that the design of the ultrasound transducer in accordance with the invention without bonding is particularly advantageous. In embodiments having a cut-out of the first part body, this cut-out is preferably arranged toward the tube wall. For the cut-out provides an asymmetric sound transmission and in the named arrangement disturbances due to effects of this asymmetry are minimized.

The measurement body preferably has thin-walled regions at which the ultrasound transducers are mounted from the outside such that a thin-walled region acts together with the oscillating body as an oscillatory membrane of the ultrasound transducers. The ultrasound transducers therefore utilize a thin-walled conduit section together with the oscillating body as the oscillatory membrane. The ultrasound transducers can thus be mounted particularly easily. At the same time, the ultrasound throughflow measurement apparatus remains completely smooth toward the interior and provides no possibilities for deposits at the ultrasound transducers or at joins between the ultrasound transducers and the inner wall of the conduit. Such deposits particularly have to be avoided in hygiene applications. Conversely, the ultrasound transducers are also protected from influences in the conduit. Particularly in the hygiene sector, pressures of up to 10 to 15 bar and temperatures of up to 140° are easily reached, for instance with steam cleaning.

An insulating layer, in particular of parylene or silicone dioxide (SiO₂), is preferably arranged between the thin-walled region and the oscillating body. An electrical insulation of the oscillating body with respect to a conductive conduit is required for detecting the piezoelectrically generated signal. With a sputtering process, parylene allows a layer thickness which is measured only in micrometers and which is admittedly electrically insulated, but remains largely without influence acoustically. A very thin layer thickness is also achievable for silicone dioxide in a CVD process and the electrical insulation is also sufficient.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to the enclosed drawing. The Figures of the drawing show in:

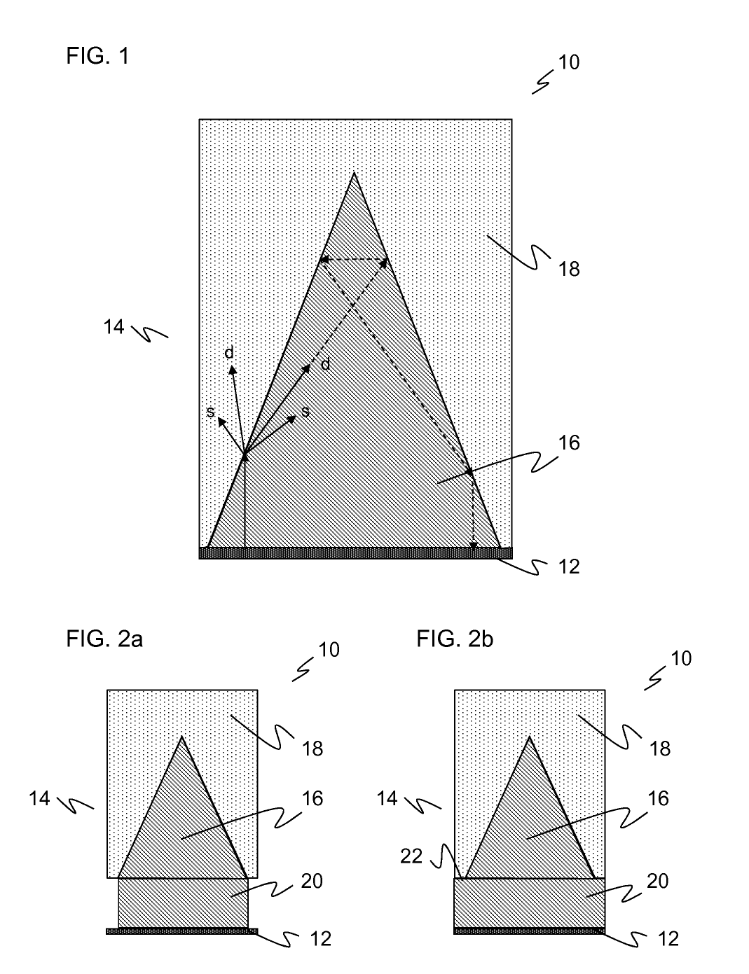

FIG. 1 a schematic sectional representation of an ultrasound transducer having an exemplary sound path with a multireflection in its damping body;

FIG. 2a a schematic sectional representation of an ultrasound transducer with a cylindrical base;

FIG. 2b a schematic sectional representation of an ultrasound transducer with a set-back cylindrical base;

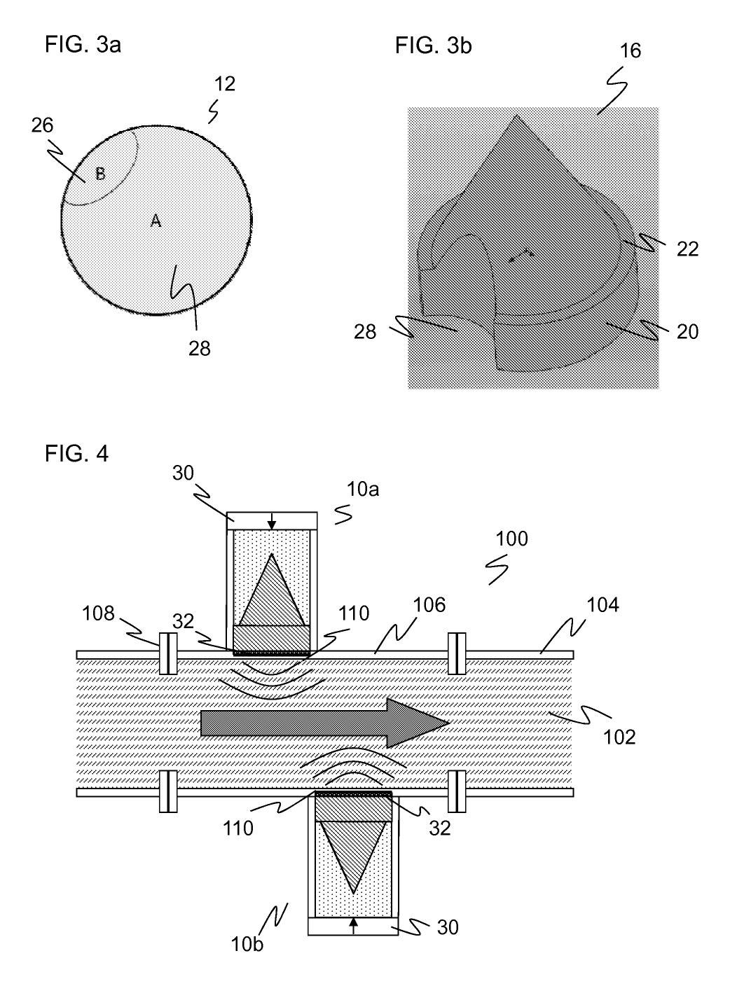

FIG. 3a a plan view of an oscillating body with two electrodes for its contact via the rear side;

FIG. 3b a three-dimensional view of a conical part body of the damping body with a cut-out for contacting an electrode of the oscillating body; and

FIG. 4 a schematic sectional view of a throughflow meter with a pair of ultrasound transducers.

FIG. 1 shows an ultrasound transducer 10 in a schematic sectional representation. In this respect, further features of an ultrasound transducer such as connectors and signal preparation devices and equally the basic piezoelectric principle of an ultrasound transducer by acoustic excitation and generation of electrons or vice versa by electrical generation of ultrasound oscillations are considered as known and are not further explained.

The ultrasound transducer 10 has an oscillatory membrane or an oscillating body 12 of a piezoelectric material, for example of a ceramic material such as PZT (lead zirconate titanate) having an acoustic impedance of in the range of 35 MRayl. The intended irradiation direction for ultrasound is directed perpendicular to a front surface of the oscillating body 12 and downwardly in the representation of FIG. 1. Ultrasound at the oppositely disposed back surface can produce interference if the ultrasound is again reflected back downwardly. A damping body (backing) is therefore arranged at the rear surface of the oscillating body 12 and is provided as a whole with the reference numeral 14.

The rear matching takes place by combination of two different materials. For this purpose, a first part body 16, for example of a metal such as brass and in particular of CuZn39Pb2, is arranged on the rear side of the oscillating body 12 and thus terminates with respect to the piezoceramic material of the oscillating body 12. Due to the material of the first part body 16 selected to match only a very small impedance jump is produced, i.e. the rearwardly irradiated wave is almost completely decoupled from the ceramic material of the oscillating body 12.

A second part body 18 of a material such as a plastic, and in particular PTFE (polytetrafluoroethylene) is arranged at the first part body 16. The material of the second part body 18 has a high acoustic damping with an acoustic impedance which is, however, substantially smaller than the material of the first part body, for example 4.4 MRayl for PTFE. The high damping of the material determines the construction length of the ultrasound transducer since the amplitude of the wave along the propagation direction is damped exponentially.

To keep small back reflections into the oscillating body from the interface between the first part body 16 and the second part body 18 of the rear damping body 14, an interface is provided geometrically between the two materials of the first part body 16 and the second part body 18 which is as large as possible. For this purpose, the first part body 16 is conical and includes an angle between 60° and 70° at its base with the back surface of the oscillating body 12.

This particular geometry has the result that the acoustic wave coming from the first part body 16 is not incident to the surface of the second part body 18 perpendicular, but rather at a slant at a specific angle not equal to the total reflection. A higher transmission into the material of the second part body 18 is thus achieved than with a perpendicular incidence. The reason for this is the coupling between the longitudinal and transverse modes since longitudinal modes are more relevant for the thick resonator used as the oscillating body 12 here.

This mode coupling in the conical structure of the damping body 14 is illustrated by the arrows in FIG. 1. Due to the slanted incidence, the wave exiting the first part body 16 propagates along the interface between the first part body 16 and the second part body 18, i.e. the multiple reflections which take place along the interface scatter the acoustic wave deeper into the formed damping wedge or damping cone. In this respect, the effect substantially depends on the angle of inclination of the interface which has to be larger than 60° to ensure forward scattering. The letters d and s at the first reflection of the incident acoustic wave designate longitudinal and transverse modes. Only the longitudinal mode not incident into the absorber of the second part body 16 contributes to interference and is shown by arrows at the further reflection points of the multiple reflection.

The wedge shape or conical shape of the first part body 16 having the complementary shape of the second part body 18, which together provide a wedge-shaped or conical interface , accordingly causes a large interface, on the one hand, and a scattering of the modes into the damping material of the second part body 18, on the other hand. The wave exiting perpendicular at the end which provides the interference contribution is therefore very considerably attenuated.

As already explained, the angle between the base of the first part body 16 and the rear surface of the oscillating body 12 should amount to at least 60°. On the other hand, theoretical models of mode coupling show that a clear reduction in the backscattered energy is achieved in the range of 65° and an angle of 65° thus represents an optimum. The optimum can, but does not necessarily have to, be exactly observed; for example, an angular range of 63°-67° or of 64°-66° is likewise suitable. In addition to the lower limit of 60°, an upper limit for the angle of 70° can be derived from the theoretical models of the mode coupling, with even larger angles moreover not being disadvantageous with respect to the required construction height. With other materials, the angular range and the ideal angle can be displaced, with the materials having similar acoustic impedances due to the required matching and thus also requiring similar angles. The angles given therefore also apply to other materials even though they were determined for a specific material combination.

In contrast to conventional matching layers which are matched to a specific wavelength range, the damping body 14 also allows a good damping for a broadband ultrasound transducer, for example having a bandwidth of 50 kHz-20 MHz or having a 6 dB bandwidth Af of 10 MHz at 10 MHz center frequency.

FIG. 2a shows a further embodiment of the ultrasound transducer 10 in a sectional representation. In this respect, here and in the following, the same reference numerals designate features which are the same or which correspond to one another. The drawings of the ultrasound transducers 10 are to scale for a preferred embodiment, with the invention not being restricted to these size relationships. The outer dimensions, that is the construction height and the diameter of the ultrasound transducer 10 which is preferably cylindrical overall, in this respect amount, for example to a centimeter to some millimeters.

The ultrasound transducer 10 in accordance with FIG. 2a differs from the ultrasound transducer 10 explained with respect to FIG. 1 by a cylindrical base 20 of the first part body 16. This base 20 is preferably not surrounded by the second part body 18. This provides technical production advantages, prevents a direct contact between the oscillating body 12 and the second part body 18 and allows a contacting of the first part body 16 from the outside.

FIG. 2b shows a further embodiment of the ultrasound transducer 10.

Unlike the ultrasound transducer 10 explained with reference to FIG. 2a, the base 20 has a larger radius than the conical part of the first part body 16. A peripheral shoulder 22 thereby results. It is thereby avoided that the complementary second part body 18 has to be manufactured with a sharp peripheral edge toward the first part body 16. This would, for example, only be achievable with difficulty from a technical production aspect for a second part body 18 of PTFE.

To control the oscillating body 12 or to detect a signal by ultrasonic excitation, electrodes for its contacting must be provided. The ultrasound transducer 10 is, however, placed with the front surface of the oscillating body 12 directly onto a conduit in a preferred embodiment, as will be explained further below in connection with FIG. 4. The front surface of the oscillating body 12 is thus not accessible.

FIG. 3a shows a plan view of an embodiment of the oscillating body 12 with two electrodes 24, 26 on its rear surface. The electrode 26 for the front surface is for this purpose drawn around the oscillating body 12 in a small region on its rear surface.

FIG. 3b shows a three-dimensional view of the first part body 16 in an embodiment matching the electrode arrangement in accordance with FIG. 3a. So that a fastening of a connector line can take place, for example, by a solder point at the drawn-around electrode 26, a cut-out 28 is provided in the first part region 16, that is the wedge shape is cut-out in a region corresponding to the electrode 26. The other electrode 24 of the rear surface is contacted over its full surface, with the exception of the cut-out 28, by the first part body 16 so that a connector line here can be soldered anywhere at the first part body 16. This contacting takes place either at the base 20 not surrounded by the second part body 18 or a corresponding passage opening is applied for the connector cable in the second part body 18. In another respect, the shoulder 22 explained with respect to FIG. 2b can be easily recognized again at the base 20 enlarged a little with respect to the cone in the three-dimensional view of the first part body 16 in accordance with FIG. 3b.

FIG. 4 shows in a schematic sectional view a throughflow meter 100 for measuring the flow speed or the flow volume of a fluid 102 in a conduit 104 with a pair of ultrasound transducers 10a-b in accordance with the invention. The determination of the flow speed takes place, for example, using the transit time method described in the introduction by evaluating the transit times on a transmission and detection of ultrasound signals between the pair of ultrasound transducers 10a-b and with and against the flow in an evaluation unit, not shown.

The flow meter 100 has a measurement body 106 which is inserted into the conduit at connection points 108 and thus ultimately forms a part of the conduit 104 in the assembled state. Indentations or thin-walled part regions 110 at which the ultrasound transducers 10a-b are mounted are provided in the measurement body 106. The thin-walled part regions 110 are thus simultaneously the fluid-side matching layer and a part of the oscillatory system. The thin-walled part regions 110 remain thick enough to withstand an inner passage pressure to be expected of, for example, 15 bar and are preferably so thin that they assist the broadband capability of the system.

Since the metallic thin-walled part regions 100 with the oscillating body 12 serve as the transducer membrane, a direct contact of the piezoceramic material of the oscillating body 12 and of the thin-walled part regions 110 by the electrical insulating layer 32 has to be avoided. Practically all electrically insulating materials, however, have a much smaller acoustic impedance than the piezoceramic material and thus produce an interfering impedance jump. This effect can be minimized if a thickness of the insulating layer 32 is achieved which is as small as possible. In particular parylene or SiO₂ are suitable for this which already insulate against hundreds of volts at layer thicknesses of a few micrometers. The layer thickness can be easily monitored by applying the insulating layer 32 in a sputtering process or in a VCD process and can be realized in the micrometer range so that the effective impedance jump remains as small as possible overall.

The conduit 104, for example, has a nominal width of approximately 10 cm and comprises, for applications in the hygiene sector, a stainless steel having an acoustic impedance of 42 MRayl slightly higher than the approximately 35 MRayl of the oscillating body 12. The fluid, in contrast, typically has a much lower acoustic impedance of, for example, 1.5 MRayl for water and for liquids based thereon.

The ultrasound transducer 10a-b built up in layers of oscillating body 12, first part body 16 and second part body 18 is pressed onto the thin-walled passage region from behind, that is in the direction toward the cone axis, toward the oscillating body 12, by means of a spring and/or by a cover 30 to be screwed on and having a thread of in particular a fine pitch. No adhesive bond connections are thus required. The two part bodies 16, 18 are automatically mutually aligned by the conical or wedge-shaped structure.

1. An ultrasound transducer (10) having an oscillating body (12) for generating and/or receiving ultrasound and having a damping body (14) which has a first part body (16) of a first material arranged at a rear side of the oscillating body (12), said first material having an acoustic impedance matched to a material of the oscillating body (12), and which has a second part body (18) of a second material arranged at the first part body (16), said second material having a high acoustic damping,
wherein the first part body (16) is conical and forms a cone and has a base surface which is arranged on the oscillating body (12).

2. The ultrasound transducer (10) in accordance with claim 1, wherein the damping body (14) is cylindrical in that the second part body (18) has a cylindrical outer contour and a conical hollow space for receiving the first part body (16).

3. The ultrasound transducer in accordance with claim 1, wherein the oscillating body (12), the first part body (16) and the second part body (18) are held together by a compressive force along the cone axis or by means of a housing cover (30) screwed onto the second part body (18).

4. The ultrasound transducer in accordance with claim 1, wherein the oscillating body (12), the first part body (16) and the second part body (18) are held together by means of a spring force which acts on the second part body (18).

5. The ultrasound transducer (10) in accordance with claim 1, wherein the jacket surface of the cone includes an angle between 60° and 75° with the base surface.

6. The ultrasound transducer (10) in accordance with claim 5, wherein the jacket surface of the cone includes an angle of approximately 65° with the base surface.

7. The ultrasound transducer (10) in accordance with claim 1, wherein the first part body (16) has a cylindrical base (20) having a larger radius than the base surface of the cone.

8. The ultrasound transducer (10) in accordance with claim 7, wherein the second part body (18) surrounds the cone, but not the cylindrical base (20) of the first part body (16).

9. The ultrasound transducer (10) in accordance with claim 1, wherein a material of the oscillating body (12) is a ceramic material.

10. The ultrasound transducer (10) in accordance with claim 1, wherein the first material is brass.

11. The ultrasound transducer (10) in accordance with claim 10, wherein the first material is CuZn39Pb2.

12. The ultrasound transducer (10) in accordance with claim 1, wherein the second material is a plastic.

13. The ultrasound transducer (10) in accordance with claim 12, wherein the second material is PTFE.

14. The ultrasound transducer (10) in accordance with claim 1, wherein the oscillating body (12) has a first electrode (26) on a front side disposed opposite the rear side and has a second electrode (24) on the rear side, with a part region of the first electrode (26) being drawn around the oscillating body (12) up to the rear side and being contacted there and the second electrode (24) being contacted via the first part body (16).

15. The ultrasound transducer (10) in accordance claim 1, wherein the first part body (16) has a cut-out (28).

16. An ultrasound throughflow measurement apparatus (100) for measuring the flow speed of fluids (102) in a conduit (104) which has a measurement body (106) which can be inserted into the conduit (104) and in this manner forms a section of the conduit (104), said measurement body having at least one pair of ultrasound transducers (10a-b) arranged therein, and also has an evaluation unit for determining the flow speed from a transit time difference of ultrasound transmitted and received with and against the flow.

17. The ultrasound throughflow measurement apparatus (100) in accordance with claim 16, wherein the measurement body (106) has thin-walled regions (110) at which the ultrasound transducers (10a-b) are mounted from the outside such that a thin-walled region (110) acts together with the oscillating body (12) as an oscillatory membrane of the ultrasound transducers (10a-b).

18. The ultrasound throughflow apparatus (100) in accordance with claim 16, wherein an insulating layer (32) is arranged between the thin-walled region (110) and the oscillating body (12).

19. The ultrasound throughflow apparatus (100) in accordance with claim 18, wherein an insulating layer (32) of parylene or SiO₂ is arranged between the thin-walled region (110) and the oscillating body (12).

20. A method of generating and/or receiving ultrasound using an oscillating body (12), wherein ultrasound is suppressed at a rear side of the oscillating body (12) by a damping body (14) which has a first part body (16) of a first material having an acoustic impedance matched to a material of the oscillating body (12) and which has a second part body (18) arranged at the first part body (16) and said second part body being of a material having a high acoustic damping,
wherein ultrasound waves reflected back by the damping body (14) into the oscillating body (12) are at least partly suppressed by multiple reflection at an interface between the conically formed first part body (16) forming a cone and the second part body (18) and by absorption in the second part body (18), said first part body (16) having a base surface and being arranged with its base surface on the oscillating body (12) and said second part body (18) surrounding a jacket surface of the cone.
